(19) United States
(12) Patent Application Publication
(10) Pub. No.: US 2007/0264925 A1
(43) Pub. Date: Nov. 15, 2007

(54) Air conditioned diffusion system

(75) Inventor: Antonio Mediato, Malaga (ES)

Correspondence Address: MICHAEL J. BUCHENHORNER, 8540 S.W. 83 STREET, MIAMI, FL, 33143, US

(73) Assignee: AIRZONE, S.L.

(21) Appl. No.: 11/433,030

(22) Filed: May 12, 2006

(51) Int. Cl. B60H 1/34

(52) U.S. Cl. 454/154

(57) ABSTRACT

An air conditioned diffusion system, for application in devices generating cool and/or warm air, includes: an apparatus to select cool air, warm air, or an off position, and for generating an external signal to control the selected working mode. The system includes a plurality of adjustable horizontal slats associated with an adjustment mechanism for the simultaneous adjustment of the horizontal slats. The system also includes an electronic circuit for acquisition and detection of the external signal, and for generating a signal representative of the selected working mode, in order to automatically direct the horizontal slats downwards when detecting that generation of warm air was selected, and to automatically direct the horizontal slats upwards when detecting that generation of warm cool was selected.

### FIELD OF THE INVENTION

The invention disclosed broadly relates to the field of air conditioning systems.

### BACKGROUND OF THE INVENTION

Air conditioning systems comprising apparatus for generating cool air, and for generating warm air, or both are known in the art. When operating air conditioning systems that use air as a final heating mechanism, the user sets the thermostat to a desired temperature for a specific location which, according to the working mode is set to cool, warm or off mode, the required temperature, and the room temperature, and thus, activates the heating or cooling system.

The generated cool or warm air is conducted into a diffusion system, whose function is to direct the flow. These diffusion systems incorporate a set of slats intended to control the air direction. Some systems provide for individual, one-by-one slat orientation, whereas other systems simultaneously orientate the slats by the actuation of a lever.

The disadvantage posed by this type of system is that in none of the aforementioned cases is the slat orientation automatically adjusted. Therefore, it is not possible to attain an optimal performance, since failure to orient airflow results in air stratifications because the driven cool air remains in the lower zone, while warm air stays in the upper zone.

### SUMMARY OF THE INVENTION

Briefly, according to an embodiment of the invention, a new system that automatically adjusts the orientation of a horizontal slat, when the working mode is selected. If the air is cool, the slats are oriented upwards, and if it is warm the slats are oriented downwards. As cool air is heavier than warm air, when directed upwards it tends to drop downwards thus achieving a more homogeneous thermal effect preventing stratification formation. Whereas the opposite occurs if the air is warm.

### BRIEF DESCRIPTION OF THE DRAWINGS

FIG. 1 shows a perspective view of the connecting rod included in the system of the invention, to provide for the simultaneous adjustment of the horizontal slats.

FIG. 2 shows a perspective view of the first end piece wherein one of the slats ends is held, and which is driven by the connecting rod shown in FIG. 1.

FIG. 3 shows a perspective view of the second end piece arranged on the other end of the slat, opposite to that lodged in the first end piece shown in FIG. 2.

FIG. 4 shows a perspective view of a part forming the cam, two parts of identical shape being used to perform the connecting rod function.

FIG. 5 shows a cross-section perspective view of a system according to the invention showing the connecting rod arrangement relative to the slats, in order to provide for their adjustment by means of the first pivoting end piece wherein one end of the slats is held.

FIG. 6 shows a perspective view of a side of the system of the invention, showing the arrangement of the connecting rod in order to provide a better understanding of the system operation.

FIG. 7 shows a cross-section side view of the system operation wherein the slats are represented in their horizontal position in a solid line, with the elastomers blocking the passage of air, and wherein the intermediate position is represented with a dashed line.

### DETAILED DESCRIPTION

We now discuss an embodiment of the invention comprising an air-conditioning diffusion system that automatically adjusts the direction of the horizontal slats forming the rack, either directing the airflow upwards, when the air is cool, or downwards when the air is warm.

A purpose of the invention is to avoid air stratification when the heating cycle is on, and to improve cool air induction when the cooling cycle is on, and also to prevent air from escaping when the horizontal slats are placed in the closed position. The invention is applicable to any air-based climate control system.

Referring to FIG. 5, a system according to the invention automatically adjusts the orientation of horizontal slats 22, when the working mode is selected. In order to achieve the objectives and to solve the aforementioned drawbacks, an air diffusion system that, like conventional systems, comprises a plurality of horizontal slats 22, which are associated with a mechanism 1 for the simultaneous adjustment of the slats 22, in order to orient the airflow. The system comprises an electronic circuit 30 for acquiring and detecting an external signal indicative of a selection of cool air or warm air generation, and a mechanism for generating an activating signal from a motor that automatically orients the horizontal slats downwards, when a warm air selection signal is detected, and that orients the horizontal slats upwards, when a cool air selection signal is detected.

Horizontal slats comprise elastomer flaps (elastomers) 27 to block air passage, when the slats are in the closed position. Located on the front face of these horizontal slats 22 there is a housing wherein a complementary flange is secured and provided in the elastomer, the latter being perfectly held in the slat; all of this is done in order to have the elastomer protruding over the slat front-end side in order to form the seal against the back side of the contiguous slat.

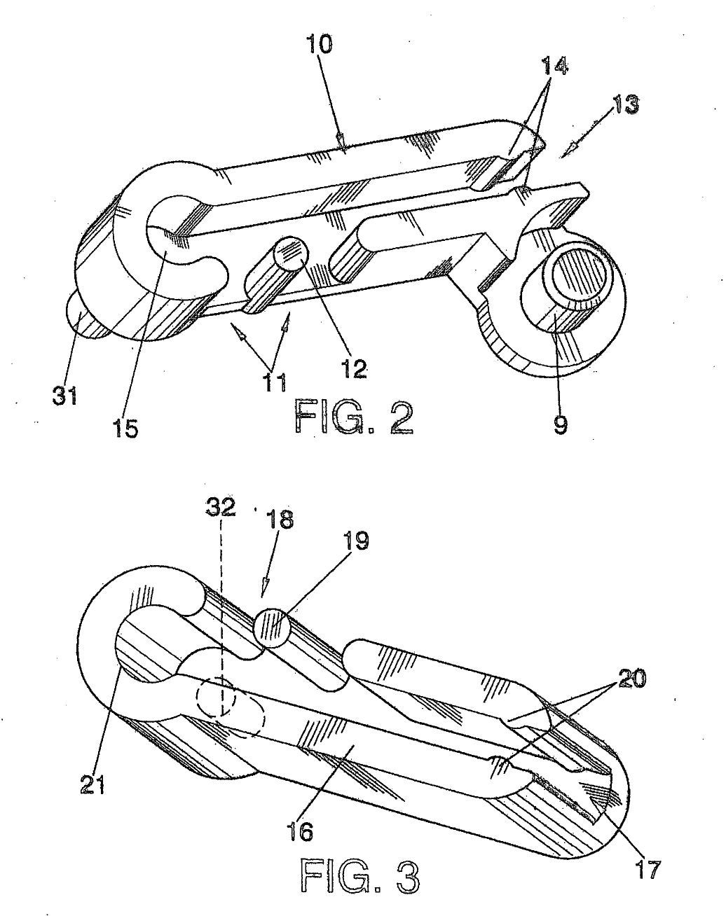

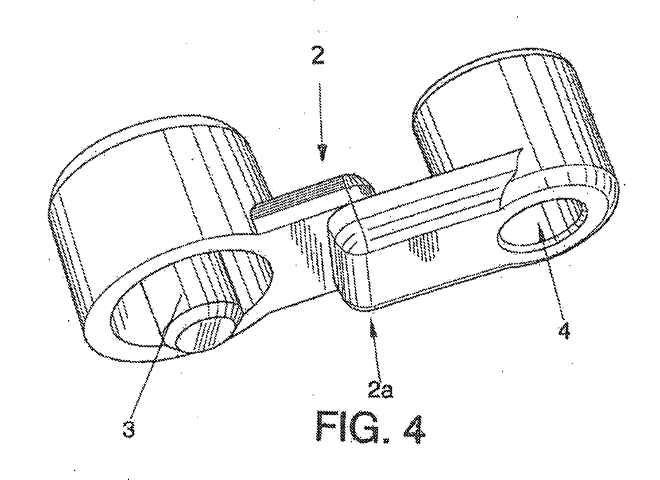

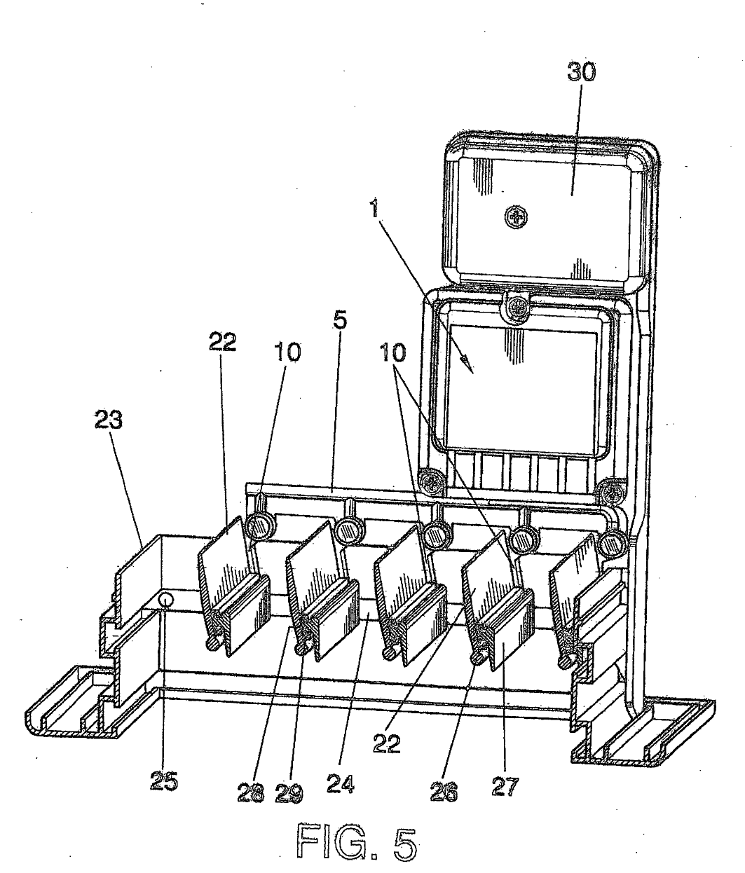

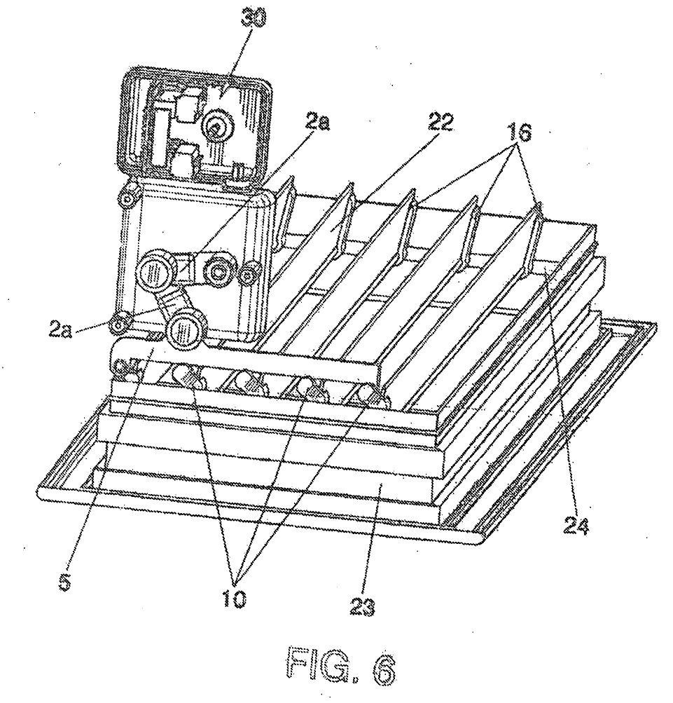

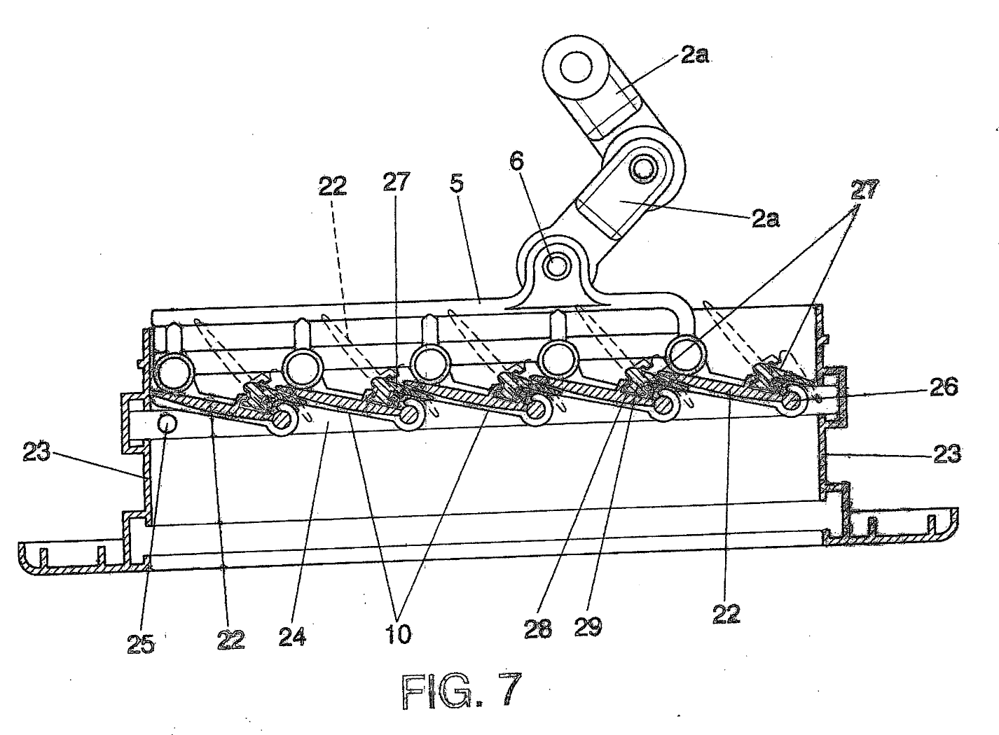

Referring to FIG. 6, the mechanism (motor) 1 for the simultaneous adjustment of the horizontal slats 22 to control the air flow though them comprises a cam 2 attached to the motor shaft, which is part of these mechanisms, in order to drive a connecting rod 5 having retention housings of a second shaft, provided on first rotating end pieces 10 and 16 (See FIGS. 2 and 3), which, in turn are provided with a mechanism for securing to an end of a slat 22, the other end being secured to a securing mechanism provided in a second end piece 16. In addition, the first end pieces 10 have a first shaft, and the second end pieces 16 have a first shaft, so that the first shafts are housed in ports made on opposing flat plates held in place by the rack mount, so that when the motor 1 is operated the cam 2 driving the connecting rod is displaced. In turn this connecting rod pushes the first end pieces 10 that rotate by means of their first and second shafts, thus causing the simultaneous angular displacement of the slats, action favored by the incorporation of the second end pieces first shaft, by means of which the other end of the slat rotates.

Both, the first and the second end pieces have a slot in which the slat end is inserted. In addition, the slot includes at least one narrowing, to compress and hold the slat end; the slot also possessing a flaring to compress and hold the slat end, thus achieving the correct retention.

Matching the complementary flange provided in the elastomer, the first and second end pieces include an opening that communicates the slot with the outside, wherein a pivot complementing an orifice made on the end of the elastomer flange has been provided, all of this to allow the elastomer insertion in the first and second end pieces.

Referring again to FIG. 5, a system according to the invention comprises a motor 1, a shaft 3 which is attached to a cam 2 formed by two members 2a provided with the shaft 3 and an orifice 4 at their ends, so that the motor shaft 3 fits in one of the orifices 4 of the member 2a, the shaft 3 of which is housed in the orifice 4 of the other member 2a, which in turn has its shaft 3 housed in an orifice 6 of a connecting rod 5, in order to cause its longitudinal and downward displacement.

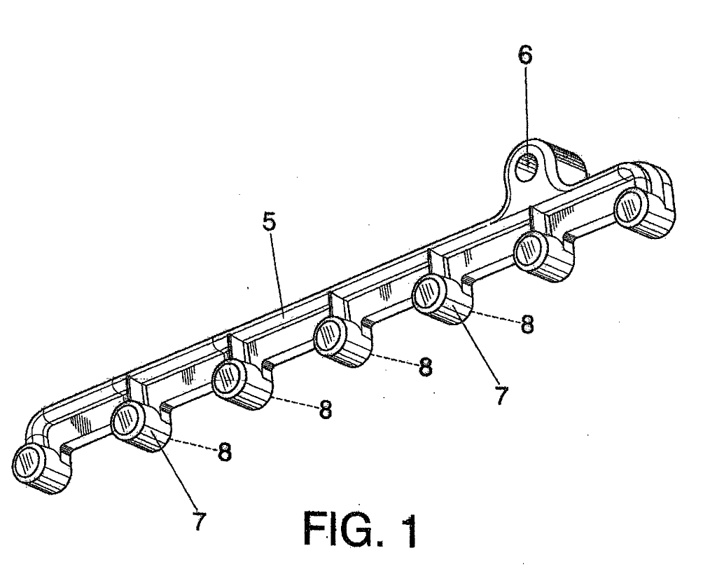

Referring to FIG. 1, the connecting rod 5 is provided with some equidistantly arranged extensions 7, each having a housing orifice 8. Referring to FIG. 2, a pivoting end piece 10 comprises a second shaft 9 and a slot 13, wherein the end of a slat 22 is inserted. To hold each slat 22 a slot 13 comprises a narrowing part 14 pushing against the side walls of the slat 22 end, and a flaring part 15 wherein a complementary flaring 26 of the slat 22 is fitted, the latter being perfectly held in the first end piece 10.

In addition, an elastomer 27 is secured at the slat 22, the elastomer blocking the air passage upon the closure of the slats, hereinafter explained; for that purpose, the slat 22 is provided with a housing 28, wherein a complementary flange 29 is held dovetail-wise, provided in the elastomer in such a way that the latter protrudes over the front-end of the slat 22 to provide a seal.

In order to create such a tight seal, the elastomer 27 is also held in the first end piece 10 which comprises an opening 11 wherein the elastomer 27 is fitted. The end piece 10 also comprises a pivot 12 complementary to an orifice made on the flange 29 end of the elastomer 27.

Further, the first end piece 10 is provided with a first shaft 31 to be inserted in an orifice 25 (see FIG. 5) of a flat plate 24 supported on a rack mount 23.

The other end of the slat 22 is held in a second end piece 16 (See FIG. 3), also comprising a slot 17 provided with a narrowing part 20, a flaring part 21, an opening 18, and a pivot 19 in order to hold the end of the slat 22 in a way similar as that described for the other end, by means of the first end piece 10. In this case, the second end piece 16 is provided with a first shaft 32 housed at the port 25 (See FIG. 5) of the flat plate 24.

Based on the above description, it is easy to understand that when motor 1 is operated, both parts 2a forming the cam 2 are driven, the cam 2 forcing the connecting rod 5 in a longitudinal and downward direction, its motion causing the angular displacement of the first end pieces 10 supporting the end of the slat 22; all of this by means of the first shaft 31, and the second shaft 9 of the first end pieces 10, in which motion the other end of the slat 22 causes the second end pieces 16 to rotate by means of their first shaft 32, resulting in the simultaneous displacement of the slats 22.

When the slats 22 are closed, their rear-ends push against that part of the elastomer 27 protruding over the front end of the slat 22, thus blocking the passage of air to the outside.

The motor 1 is driven by an electronic circuit 30 comprising a mechanism for the acquisition and detection of an external signal indicative of the working mode selected on the apparatus, either a signal for the generation of cool air, warm air or off position. The electronic circuit also comprising a mechanism for the generation of a signal to control the motor rotation based on the external signal received, in order to automatically direct the horizontal slats 22 downwards when detecting the signal selected for warm air, and to direct the horizontal slats upwards when detecting the signal selected for cool air, thus providing a better performance of the conditioning system.

In front of the horizontal slats 22, the system also incorporates vertical slats, not shown in the figures, because their operation is identical to that provided by the conventional systems.

Therefore, while there has been described what is presently considered to be the preferred embodiment, it will understood by those skilled in the art that other modifications can be made within the spirit of the invention.

We [I] claim:

1. An indoor air conditioning diffusion system, for application in devices generating cool or warm air flow, the system comprising:
a selection apparatus to select a working mode wherein any of cool air, warm air, or an off mode is selected, and for generating an external signal representing the selected mode to control the system;
a plurality of adjustable horizontal slats for directing the air flow outwards;
an adjustment apparatus for the simultaneous adjustment of the position of each of the horizontal slats in response to the external signal;
the adjustment apparatus further comprising
an electronic circuit for acquisition and detection of the external signal, and for generating a signal representative of the selected working mode, in order to automatically direct the horizontal slats downwards to expel warm air downwards when detecting that generation of warm air was selected, and to automatically direct the horizontal slats upwards to expel cool air upwards when detecting that generation of cool air was selected.

2. The air conditioning diffusion system of claim 1, wherein the adjustment apparatus for the simultaneous adjustment of the horizontal slats comprises:
a motor driven by the selection apparatus for generating a signal indicative of the selected working mode; and
a shaft which is attached to a cam activating a connecting rod provided with retention housings of a second shaft, provided in first end pieces, comprising securing apparatus to secure the end of each slat, the other end of which is held in a securing mechanism of a second end piece; the first end piece having a first shaft, and the second end piece having shaft housed in orifices of opposing flat plates and provided on a rack mount to drive the motor, in order to cause the displacement of the cam, the connecting rod and of the end pieces rotating by means of their first shaft and their second shaft, causing the angular displacement of the slats, and of the second end pieces by means of its first shaft.

3. The air conditioning diffusion system of claim 2, wherein a mechanism for securing the ends of the slat provided on the first end piece and second end piece, respectively comprise a slot having at least one narrowing part to be compressed against the slat when inserting its end into each slot and each slot having a flaring part wherein a complementary flaring of the slat is fitted

4. The air conditioning diffusion system of claim 2, wherein both the first end piece and the second end piece each has an opening, connecting each slot with the outside, and comprising a complementary pivot of an orifice made on an elastomer flange, in order to incorporate its ends in the first end piece and in the second end piece.

5. The air conditioning diffusion system of claim 1, wherein the adjustment apparatus comprises:
a motor having a motor shaft; and
a cam having a shaft and an orifice, wherein the shaft in turn is held in the orifice made on a connecting rod.

6. The air conditioning diffusion system of claim 1, wherein the horizontal slats each comprise an elastomer to block the passage of air by placing the horizontal slats in a closed position.

7. The air conditioning diffusion system of claim 1, wherein each elastomer has a complementary extension to a housing provided on the front face of the slats in order to secure the elastomer on the slats, the elastomer protruding over the front-end side of the slat to seal against the rear-end side of the adjacent slat.
